(19) United States
(12) Patent Application Publication
(10) Pub. No.: US 2015/0304014 A1
(43) Pub. Date: Oct. 22, 2015

(54) MULTIPLE-INPUT AND MULTIPLE-OUPTUT (MIMO) ENHANCEMENT FOR BACKHAUL RELAYS

(71) Applicants: Pouriya Sadeghi, Verdun (CA); Shahrokh Nayeb Nazar, Sainte-Julie (CA)

(72) Inventors: Pouriya Sadeghi, Verdun (CA); Shahrokh Nayeb Nazar, Sainte-Julie (CA)

(73) Assignee: INTERDIGITAL PATENT HOLDINGS, INC., Wilmington, DE (US)

(21) Appl. No.: 13/571,023

(22) Filed: Aug. 9, 2012

Related U.S. Application Data
(60) Provisional application No. 61/522,383, filed on Aug. 11, 2011.

(51) Int. Cl. H04B 7/14; H04B 7/04; H04L 5/00; H04L 27/26

(52) U.S. Cl. CPC H04B 7/14; H04L 27/26; H04B 7/0413; H04L 5/0048; H04W 88/08

(57) ABSTRACT

Embodiments contemplate one or more methods and apparatuses for allocating demodulation reference signals (DRSs) for a backhaul link between a base station and a relay. One or more embodiments include a processor that may generate a plurality of orthogonal cover codes (OCCs) as a reference for demodulation at a reception end of the backhaul link. The processor may allocate the generated plurality of OCCs in DRS groups to selective resource elements of one or more orthogonal frequency division multiplexed (OFDM) symbols that may be associated with a subframe.

### CROSS REFERENCE TO RELATED APPLICATIONS

This application claims the benefit of U.S. Provisional Patent Application No. 61/522383, titled “Methods and Apparatus for MIMO Enhancement for Backhaul Relays”, filed on Aug. 11, 2011, the contents of which hereby incorporated by reference in its entirety, for all purposes.

### BACKGROUND

Relays may be fixed network base stations. Relays may connect wireless communication networks via an in-band wireless backhaul link instead of using a dedicated wired or wireless backhaul link as regular base stations may do. In-band relaying may involve the same radio resources being used both by relays and by user equipment such as mobile phones and the like.

Relays may provide coverage extension to regions where dedicated backhaul links are not available. In some wireless communication networks, relaying functionality may be provided by relay nodes that may connect to an enhanced (or evolved) NodeB (eNodeB or eNB), which may be referred to as the Donor eNodeB (DeNB) for that particular relay node.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments contemplate to methods and apparatus for allocating demodulation reference signals (DRSs, sometime referred to as DMRSs) for a backhaul link between a base station and a relay. One example method may include the processor generating a plurality of orthogonal cover codes (OCCs) as a reference for demodulation at a reception end of the backhaul link; and allocating the generated plurality of OCCs in DRS groups to selective resource elements of one or more orthogonal frequency division multiplexed (OFDM) symbols associated with a subframe such that the OCCs are of length six.

Another example method may include a processor generating a plurality of orthogonal cover codes (OCCs) as a reference for demodulation at a reception end of the backhaul link; and allocating the generated plurality of OCCs in DRS groups to selective resource elements of one or more orthogonal frequency division multiplexed (OFDM) symbols associated with a subframe such that each respective DRS group is allocated to a respectively different one or ones of the plurality of OFDM symbols associated with the subframe.

A further example method may include a processor generating a plurality of orthogonal cover codes (OCCs) as a reference for demodulation at a reception end of the backhaul link; and allocating the generated plurality of OCCs in DRS groups to selective resource elements of one or more orthogonal frequency division multiplexed (OFDM) symbols associated with at least one of: (1) a first timeslot of a subframe such that the OCCs of each respective DRS group are not allocated to a second timeslot of the subframe or (2) a first subset of subcarriers of the subframe such that the OCCs of each respective DRS group are not allocated to a plurality of beginning or a plurality of an ending subcarriers of the subframe.

In certain example embodiments, the processor may select, based on measured results, one of a plurality of DRS patterns defined by the positions of the OCCs in the resource block of the subframe.

In certain example embodiments, the allocating of the generated plurality of OCCs in DRS groups may be based on the selected one of the DRS patterns.

In certain example embodiments, the generating of the OCCs may include generating one of a plurality of different orthogonal codes, each allocated to a different resource element of a selected OFDM symbol.

In certain example embodiments, the allocating of the generated plurality of OCCs in DRS groups to selective resource elements of one or more OFDM symbols may include allocating the DRS groups to consecutive OFDM systems in a resource block.

In certain example embodiments, the allocating of the generated plurality of OCCs in DRS groups to selective resource elements of one or more OFDM symbols may include allocating the DRS groups to selective consecutive subcarriers of a resource block.

In certain example embodiments, the allocating of the generated plurality of OCCs in DRS groups to selective resource elements of one or more OFDM symbols may include allocating the DRS groups to consecutive OFDM systems in first and second resource blocks of the subframe such that the selective resource elements in the first and second resource blocks correspond to common subcarriers.

In certain example embodiments, the allocating of the generated plurality of OCCs in DRS groups to selective resource elements of one or more OFDM symbols may include allocating the DRS groups to consecutive OFDM systems in first and second resource blocks of the subframe such that the selective resource elements in the first and second resource blocks correspond to different subcarriers.

In certain example embodiments, the allocating of the generated plurality of OCCs in DRS groups to selective resource elements of one or more OFDM symbols may include allocating the DRS groups to consecutive subcarriers in first and second resource blocks of the subframe such that the selective resource elements in the first and second resource blocks correspond to common subcarriers.

In certain example embodiments, the allocating of the generated plurality of OCCs in DRS groups to selective resource elements of one or more OFDM symbols may include allocating the DRS groups to consecutive subcarriers in first and second resource blocks of the subframe such that the selective resource elements in the first and second resource blocks correspond to at least one different subcarrier.

An additional example method for transmission using a backhaul link between a base station and a relay may include a base station establishing the backhaul link with more than 4 multiple-input-multiple-output (MIMO) layers; and communicating to the relay, via more than 4 antennas using corresponding MIMO layers.

In certain example embodiments, the relay may be a mobile relay and may move while communicating via the more than 4 antennas.

In certain example embodiments, the communicating, by the base station to the relay, via more than 4 antennas using corresponding MIMO layers may include communicating using one of: single user or multiple users MIMO.

An example base station for allocating demodulation reference signals (DRSs) for a backhaul link between the base station and a relay may include a processor configured to: (1) generate a plurality of orthogonal cover codes (OCCs) as a reference for demodulation at a reception end of the backhaul link; and (2) allocate the generated plurality of OCCs in DRS groups to selective resource elements of one or more orthogonal frequency division multiplexed (OFDM) symbols associated with a subframe; and a transmitter/receiver unit configured to send a backhaul communication including the subframe to the relay. Either the OCCs may be of length 6, or each respective DRS group may be allocated to a respectively different one or ones of the plurality of OFDM symbols associated with the subframe.

Another example base station may include a processor configured to: (1) generate a plurality of orthogonal cover codes (OCCs) as a reference for demodulation at a reception end of the backhaul link; and (2) allocate the generated plurality of OCCs in DRS groups to selective resource elements of one or more orthogonal frequency division multiplexed (OFDM) symbols associated with at least one of: (1) a first timeslot of a subframe such that the OCCs of each respective DRS group are not allocated to a second timeslot of the subframe; or (2) a first subset of subcarriers of the subframe such that the OCCs of each respective DRS group are not allocated to a plurality of beginning or a plurality of an ending subcarriers of the subframe; and a transmitter/receiver unit configured to send a backhaul communication including the subframe to the relay.

An example relay for receiving a communication including allocated demodulation reference signals (DRSs) using a backhaul link between a base station and the relay, may include a transmitter/receiver unit configured to receive the communication including the allocated DRSs; and a processor configured to: (1) determine a plurality of orthogonal cover codes (OCCs) as a reference for demodulation at the relay in the DRSs; and (2) demodulate the communication based on the OCCs of the DRSs, the plurality of OCCs allocated in DRS groups to selective resource elements of one or more orthogonal frequency division multiplexed (OFDM) symbols associated with a subframe of the communication.

Embodiments contemplate one or more devices that may comprise a processor. In one or more embodiments, the processor may be configured, at least in part, to generate one or more orthogonal cover codes (OCCs) as a reference for demodulation at a reception end of a backhaul link. The processor may also be configured to allocate the one or more OCCs in one or more demodulation reference signal (DRS) groups to one or more resource elements of one or more orthogonal frequency division multiplexed (OFDM) symbols associated with a subframe. In one or embodiments, the one or more OCCs may be generated in the time domain. In one or more embodiments, each of the one or more OCCs may have a length of at least two OCC symbols. Alternatively or additionally, in some embodiments the one or more OCCs may be generated in the frequency domain. In one or more embodiments, each of the one or more OCCs may have a length of up to six OCC symbols. Alternatively or additionally, embodiments contemplate that the one or more OCCs may be generated in one or more OCC sequences, where each of the one or more OCC sequences may include the up to six OCC symbols per the one more OCCs. Further, in some embodiments, each of the respective OCC sequences may be orthogonal to the other OCC sequences.

Embodiments contemplate one or more methods that may include generating one or more orthogonal cover codes (OCCs) by a first device of a wireless communication network as a reference for demodulation at a reception end of a backhaul link between the first device and a second device of the wireless communication network. One or more embodiments also contemplate allocating by the first device the one or more OCCs in one or more demodulation reference signal (DRS) groups to one or more resource elements of one or more orthogonal frequency division multiplexed (OFDM) symbols associated with a subframe. In one or more embodiments, the allocating the one or more OCCs in the one or more DRS groups to the one or more resource elements of the one or more orthogonal frequency division multiplexed (OFDM) symbols may include allocating the one or more DRS groups to adjacent OFDM symbols of the subframe such that the resource elements corresponding to the adjacent OFDM symbols may correspond to a common subcarrier. Alternatively or additionally, one or more embodiments contemplate that the allocating the one or more OCCs in the one or more DRS groups to the one or more resource elements of the one or more orthogonal frequency division multiplexed (OFDM) symbols may include allocating the DRS groups to adjacent OFDM symbols of the subframe such that the resource elements corresponding to the adjacent OFDM symbols may correspond to at least one different subcarrier.

Embodiments contemplate one or more devices that may include a processor. The processor may be configured, at least in part, to establish a backhaul link to a second device with more than four multiple-input-multiple-output (MIMO) layers. In one or more embodiments, the processor may be configured to initiate communication to the second device via more than four antenna using corresponding layers of the more than four MIMO layers. In some embodiments the communication may include configuration information for a control channel for the second device to operate the backhaul link with the more the four MIMO layers. In one or more embodiments, the configuration for the control channel may include at least one of a reference signal antenna port, an orthogonal cover code (OCC) index, a number of layers, a reference signal scrambling sequence, or a precoding matrix indicator (PMI). One or more embodiments contemplate that the second device is a relay node.

### BRIEF DESCRIPTION OF THE DRAWINGS

A more detailed understanding may be had from the Detailed Description below, given by way of example in conjunction with drawings appended hereto. Figures in such drawings, like the detailed description, are examples. As such, the Figures and the detailed description are not to be considered limiting, and other equally effective examples are possible and likely, wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram illustrating an example communications system including a relay consistent with embodiments;

FIGS. 3A, 3B and 3C are exemplary timing diagrams illustrating timing offsets and propagations associated with relayed communications consistent with embodiments;

FIGS. 4A and 4B are example time slot diagrams illustrating Demodulation Reference Signal (DMRS) locations associated with different Down Link (DL) timing offsets and propagations of FIGS. 3A to 3C consistent with embodiments; and

FIGS. 5A to 5F are other example timeslot diagrams illustrating Demodulation Reference Signal (DMRS) locations associated with different Down Link (DL) timing offsets and propagations of FIGS. 3A to 3C in accordance with certain example embodiments.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application. As used herein, the article “a” or “an”, absent further qualification or characterization, may be understood to mean “one or more” or “at least one”, for example. Also, as used herein, the phrase user equipment (UE) may be understood to mean the same thing as the phrase wireless transmit/receive unit (WTRU).

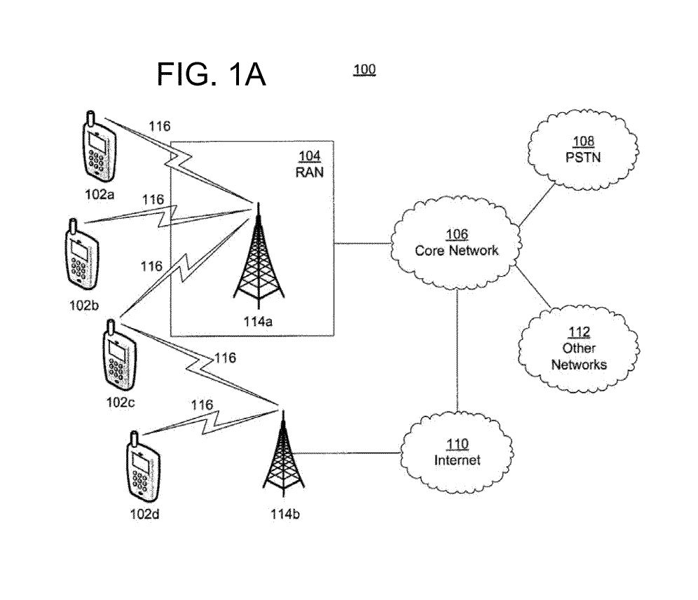

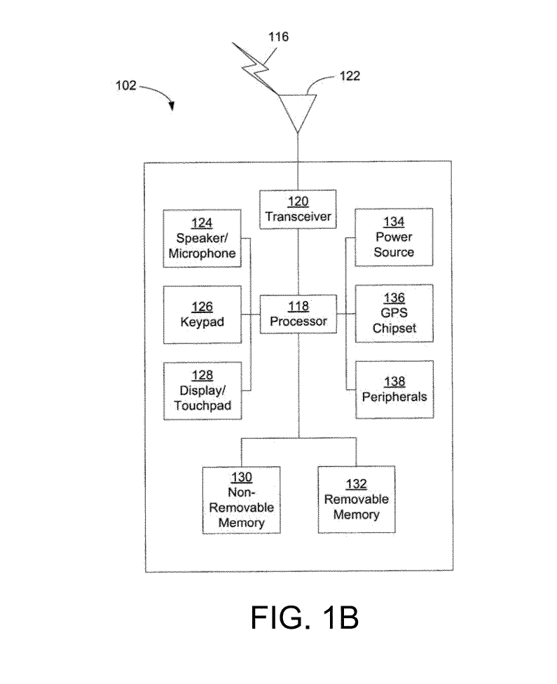

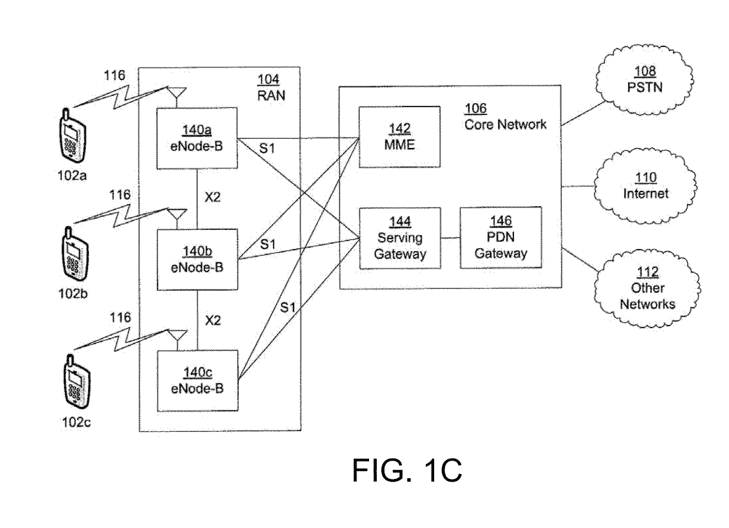

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

In certain example methods, relays (e.g., LTE relays) may be improved using DL Single User MIMO (SU-MIMO) and/or Multi-User MIMO (MU-MIMO) by considering: (1) relay backhaul channel conditions; and/or (2) Relay Node (RN) timing conditions (e.g., requirement and other conditions) for example, in LTE and LTE-A. For example, relay SU-MIMO and DMRS enhancements may include: (1) enhancements to the existing and/or new Orthogonal Cover Codes (OCCs) in time-domain (e.g., OCC over, for example, one subcarrier); (2) enhancements to the existing and/or new OCCs in frequency-domain (e.g., OCC over, for example, one OFDM symbol); and/or (3) reductions to DMRS overhead, for example, by reducing allocated Resource Elements (Res) in the time-domain and/or frequency-domain.

Embodiments contemplate that relay MU-MIMO enhancements may include: (1) increasing MU-MIMO layers for RN data channel in the frequency-domain and/or the time-domain; (2) applying MU-MIMO to RN control channel; and (3) applying MU-MIMO between or among relay nodes (RN) and macro-UEs (mUEs).

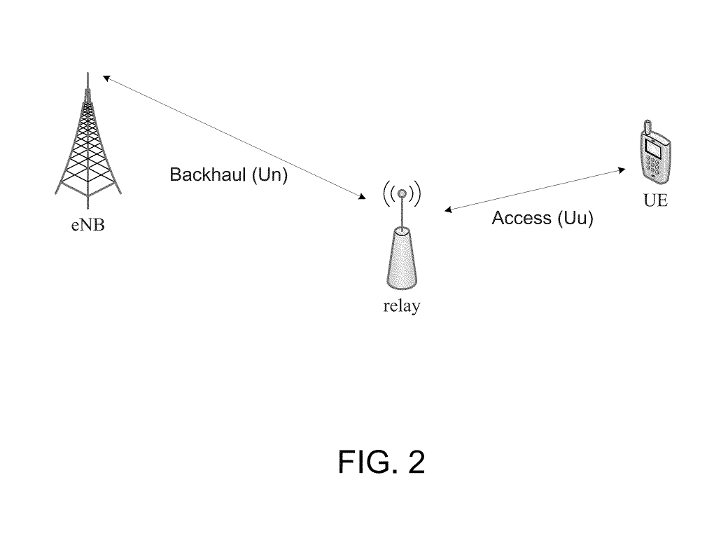

In certain example embodiments the increased MIMO layers may be implemented using Layer 1 (L1) and Layers 2 and/3 (L2/3). FIG. 2 is a diagram illustrating an example communications system including a relay.

In certain example embodiments, type-1 relays may be included in the communications system, such as a LTE Release 10 (Rel-10) communications system. A type-1 relay may create one or more new cells that may be distinguishable and separate from the macro cells (e.g., eNB or DeNB). To any legacy Release-8 (Rel-8) UE, the type-1 relay may appear as an eNB (e.g., the presence of a type-1 relay may be transparent to the UE). The type-1 RN may be to such a UE, for example, an eNB that has a wireless in-band backhaul link (Un) to the DeNB (e.g., using an LTE or LTE-A air interface within the same spectrum allocation as the access link (Uu)).

Referring to FIG. 2, in certain example embodiments, due to in-band self interference (the relay's transmission interfering with the relay's reception), a type-1 relay node may not be able to simultaneously transmit to the UE on the access link (Uu) while receiving from the eNB or DeNB on the backhaul link (Un) in the DL frequency channel shared between the access and backhaul links, or receive from a UE on the access link while transmitting to the DeNB in the UL frequency channel shared between access and backhaul links.

To accommodate both backhaul and access communications on the same downlink frequency channel, the subframes may be shared between these connections using Time Division Multiplexing (TDM). As a first example, if a subframe is allocated for the backhaul downlink, it may not be used for the access downlink, and if a subframe is allocated for the access downlink, it may not be used for the backhaul downlink. As a second example, if a subframe is allocated for the backhaul uplink, it may not be used for the access uplink, and if a subframe is allocated for the access uplink, it may not be used for the backhaul uplink.

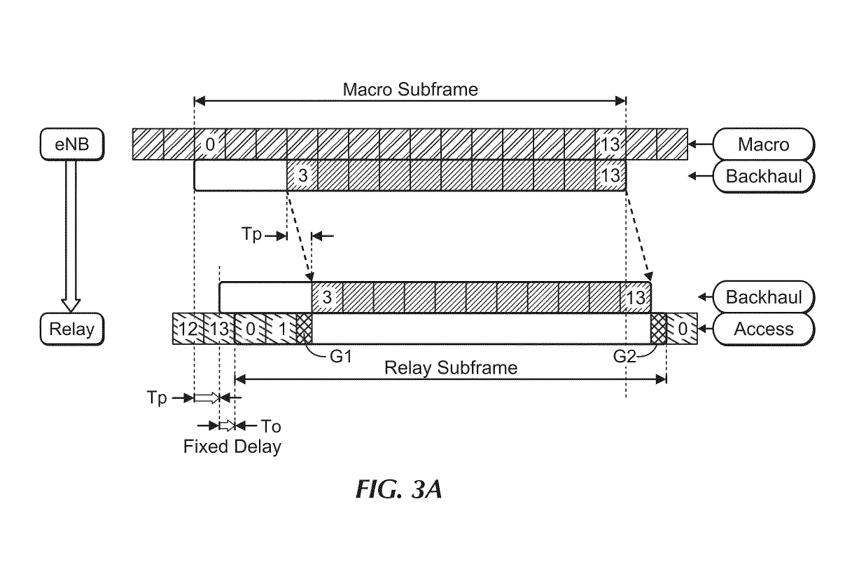

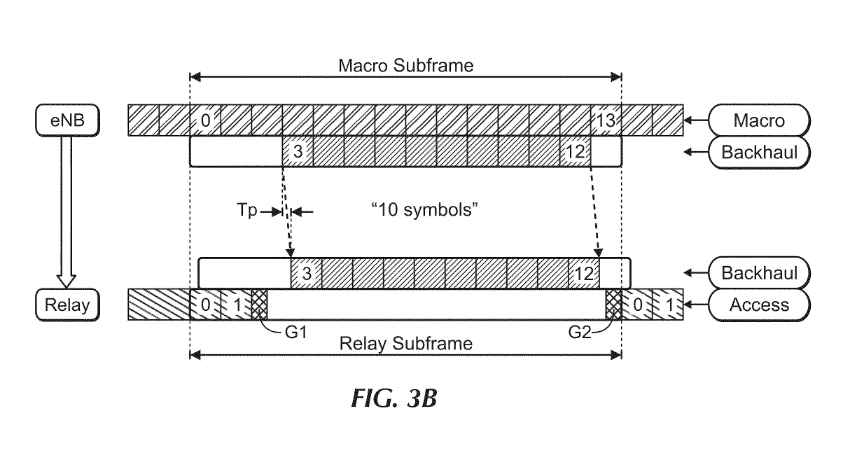

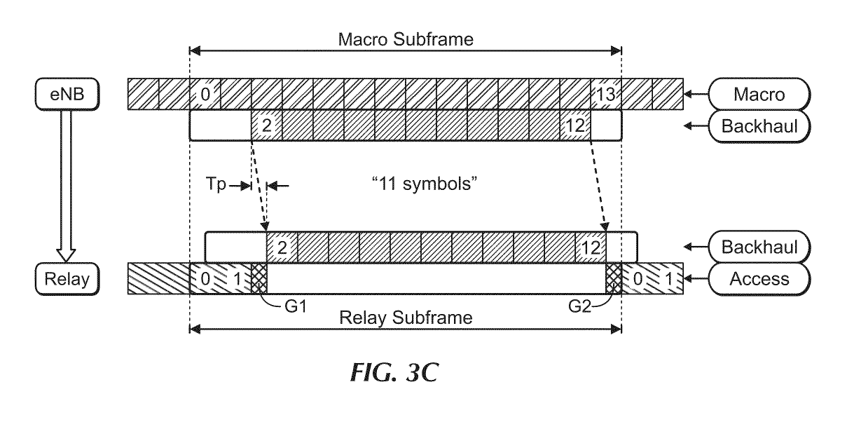

FIGS. 3A, 3B and 3C are timing diagrams illustrating timing offsets and propagations associated with relayed communications. Referring to FIGS. 3A, 3B and 3C, consideration may be taken for relay implementations based on the DL timing between the RN and the eNB or DeNB, where the RN can receive Un DL transmissions starting with OFDM symbol numbered m and can stop receiving with the OFDM symbol numbered n where the OFDM symbol numbering within the subframe starts at 0, and k is equal to the number of OFDM symbols that may be used for the L1/L2 control region at the RN access.

In one example (referred to as Example 1 (E1)), the DL timing between RN and the DeNB may include that the RN can receive the DL backhaul subframe starting from OFDM symbol m=k+1 until the end of the subframe (e.g., n=13 for normal cyclic prefix (CP) or n=12 for the extended CP). E1 may correspond to the case when RN switching time may be longer than the CP (e.g., the RN switching time is greater than the CP) and the RN DL access transmit time may be offset (e.g., slightly offset) with respect to the DL backhaul reception time at the RN. FIG. 3A corresponds to E1 and may include a fixed timing offset (To) in addition to propagation delay (Tp) between the macro subframes and the relay subframes.

In a second example (referred to as E2), the DL timing between RN and the DeNB may include that the RN can receive the DL backhaul subframe starting from OFDM symbol m=k until the end of the subframe (e.g., n=13 for normal cyclic prefix (CP) or n=12 for the extended CP). E2 may correspond to the case when RN switching time may be shorter (e.g., sufficiently shorter) than the CP and the RN DL access transmit time may be aligned to the DL backhaul reception time at the RN. FIG. 3B corresponds to E2 where the eNB DL transmit (TX) timing may be aligned to the RN DL TX timing, (such that, for example, (Tp<L), (Tp<G1) and (Tp+G2<L), where symbol_length=L], which may be referred to as the “small propagation delay.”

In a third example (referred to as E3), the DL timing between RN and the DeNB may include that the RN can receive the DL backhaul subframe starting from OFDM symbol m until OFDM symbol n<13 (e.g., depending on the propagation delay and the switching time) This corresponds to the case when RN DL Uu transmissions may be synchronized with the eNB DL transmissions. FIG. 3C corresponds to E3 where the eNB DL TX timing may be aligned to the RN DL TX timing, (such that, for example, [(G1<Tp<L) and (Tp+G2<L), which may be referred to as the “medium propagation delay.”

In a fourth example (referred to as E4), the DL timing between RN and the DeNB may include that the RN can receive the DL backhaul subframe starting from OFDM symbol 0 until OFDM symbol n=13−(k+1). This corresponds to the case when RN can receive the normal PDCCH, for example.

Embodiments contemplate one or more Relay DL Slot Structures and DMRS (DRS) symbols. Table 1 shows the location of the OFDM symbols for an exemplary eNB-to-RN transmission in the first slot (e.g., with normal CP and Δf=15 kHz) and Table 2 shows the OFDM symbols for the exemplary eNB-to-RN transmission in the second slot (e.g., with normal CP and Δf=15 kHz). The DL slot structure corresponding to DL timing of E1 and E3 may include that the eNB-to-RN transmissions may be restricted to a subset of the OFDM symbols in a slot. The starting and ending OFDM symbols may be as given respectively in Embodiments contemplate one or more Relay DL Slot Structures and DMRS (DRS) symbols. Table 1 for the first slot of a subframe and in Table 2 for the second slot of the subframe. The parameter DL-StartSymbol in Embodiments contemplate one or more Relay DL Slot Structures and DMRS (DRS) symbols. Table 1 is configured by higher layers, such as the network and/or application layers, among others. If the downlink subframes are transmitted with time aligned subframe boundaries by the eNB (e.g., donor eNB) and the RN (e.g., E3 timing), configuration 1 of Table 2 is used; and otherwise, configuration 0 is used. The simultaneous operation of configuration 0 in Embodiments contemplate one or more Relay DL Slot Structures and DMRS (DRS) symbols. Table 1 and configuration 0 in Table 2 may not be supported. Tables 1 and 2 are as follows:

TABLE 1

| Configuration | DL-StartSymbol | End symbol index |
|---|---|---|
| 0 | 1 | 6 |
| 1 | 2 | 6 |
| 2 | 3 | 6 |

TABLE 2

| Configuration | Start symbol index | End symbol index |
|---|---|---|
| 0 | 0 | 6 |
| 1 | 0 | 5 |

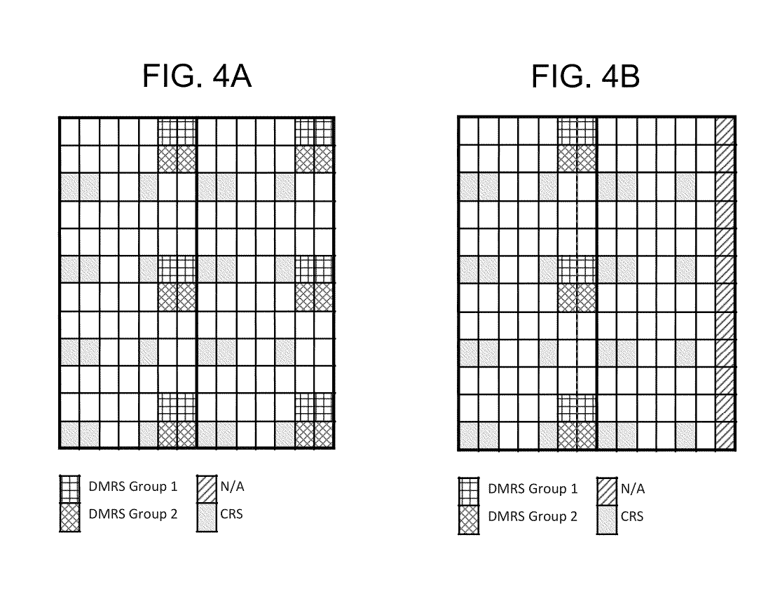

The reference signal sequence of antenna ports 7, 8, 9 and 10 may (e.g., may only) be mapped to resource elements in the first slot of a PRB pair used for eNB-to-RN transmission when configuration 1 in Table 2 is used. One example of such configuration is DL timing of E3 where the last OFDM symbol of the subframe is not available to RN. The location of DMRS symbols are illustrated in FIG. 4A corresponding to E1 and FIG. 4B corresponding to E3. In FIG. 4B, the number of locations of DMRS may be reduced such that the DMRS may be located in slot 1 of a subframe (e.g., located in slotl of the subframe (and in some embodiments perhaps only in slot 1 of the subframe), but not in slot 2 of the subframe).

Because antenna ports 11 to 14 may not be used for eNB-to-RN transmission in Rel-10 up to 4 layers may be supported in the Un DL data (and perhaps only up to four layers). Embodiments recognize that Rel-10 relays have been introduced as eNBs with a wireless backhaul. Consequently, it is contemplated that certain optimization and/or improvements may be possible for current releases, Release 11, and beyond (e.g., Rel-11+ relays). For example, embodiments contemplate that MIMO functionality for relay backhaul may be revised/updated, for example, to improve throughput.

The backhaul channel (e.g., link) of relays may be different from that of UEs. For example, in Rel-10 (perhaps only) fixed relays are considered, e.g., once a relay position is determined and it is connected to a DeNB, it may not move nor be handed over to another DeNB. The system operator may optimize the initial relay deployment by placing the Rel-10 relay at a location with a relatively good channel condition towards the designated DeNB in an area of interest. This process is generally referred to as the relay site planning. Due to this relay site planning, the probability of a Line of Site (LOS) channel condition for the relay backhaul may be considerably higher than that of the regular UEs. Because Rel-11+ relays may be mobile, relay site planning may not be applicable Rel-11 and beyond).

Other differences between relays and UEs may be that one of the antenna configuration options for relay backhaul may use directional antennas directed towards the DeNB and/or the RF components used for relays may be less restricted in terms of cost, form factor, and/or power consumption, compared to those used for UEs. Such factors, as well as the relay site planning for fixed relays, make the relay backhaul channel likely to be more reliable than the channel of a typical UE. The channel diversity of the relay backhaul, however, may be lower than that of a UE, for example, due to the higher probability of LOS.

Embodiments recognize that the channel condition of the relay backhaul may be considerably different from that of the UEs. Indeed, the MIMO techniques within the Rel-10 framework were designed for a typical UE mobility pattern and channel condition. Embodiments contemplate that such techniques may be optimized, and modified, for the relay backhaul in order to achieve a better performance and/or throughput for Rel-11+ relays, and the UEs they serve. These improvements may include, but not limited to, designing and/or revising the DMRS structure, reducing the signaling overhead for MIMO, improving the MU/SU-MIMO, and/or the application of MIMO to control channel, among others.

Although the DMRS structures are shown in connection with type 1 relays, it is contemplated that these structures may be used with other types of relays such as relay types 1a, and 1b, among others.

Embodiments contemplate that the reference signals include symbols transmitted at a well-defined OFDM symbol position in a timeslot to assist a UE in estimating the channel impulse response to compensate for channel distortion in the received signal. In some embodiments, there may be one reference signal transmitted per downlink antenna port and a unique symbol position may be assigned for an antenna port such that when one antenna port is transmitting a reference signal, the other ports may be silent. Reference signals (RS) may be used to determine the impulse response of the physical channels.

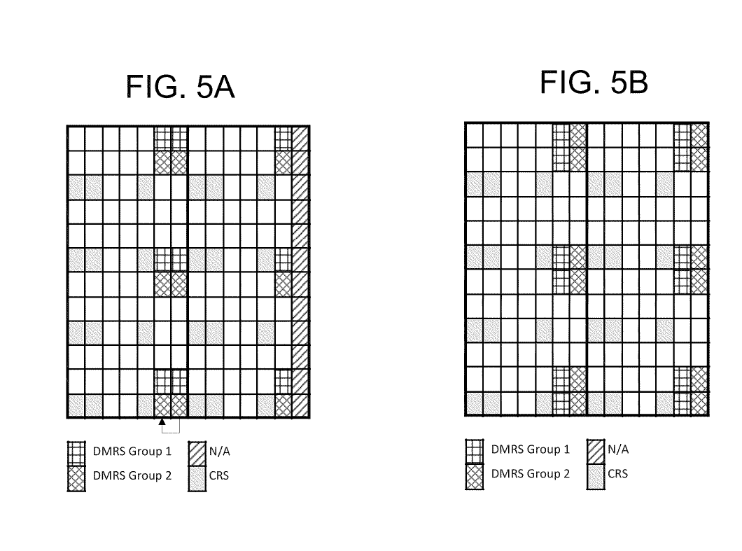

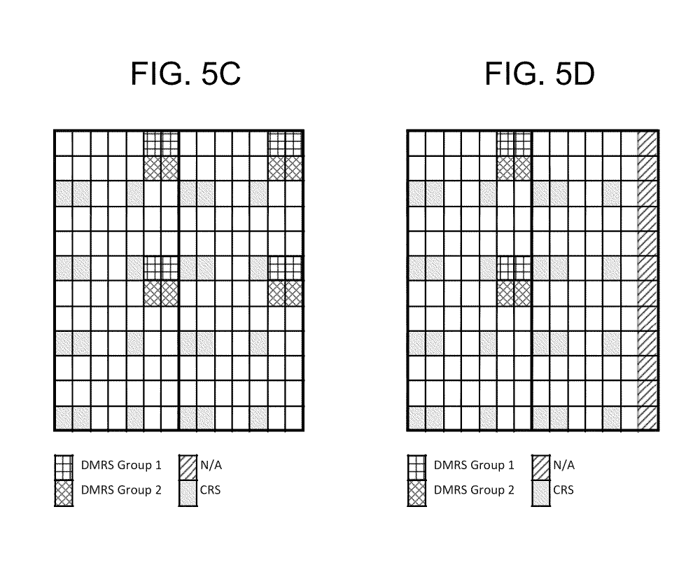

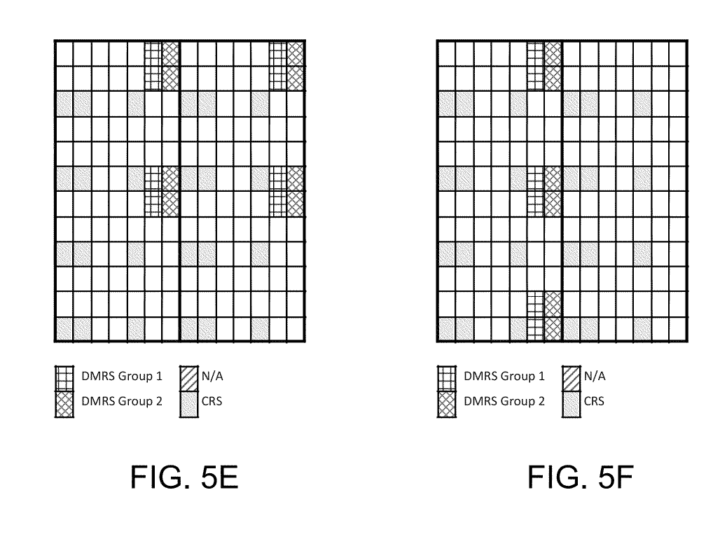

Embodiments contemplate DMRS (or DRS) structural changes. FIGS. 5A to 5F are other example time slot diagrams illustrating Demodulation Reference Signal (DMRS or DRS) locations associated with different Down Link (DL) timing offsets and propagations of FIGS. 3A to 3C in accordance with certain example embodiments.

DMRS symbols were originally designed for UEs considering their typical mobility pattern and channel condition. Embodiments contemplate that the relay backhaul channel condition may be considerably better than the channel between UE and eNB for which DMRS may be originally designed for and consequently, the DMRS may be further optimized to this channel condition. In some scenarios such as the timing in E3, the last OFDM symbol of the subframe and its corresponding DMRS symbols may not be available to the relays due to the relay timing arrangement. This may result in limitations to the MIMO operation modes for the relay backhaul (e.g., only up to 4 layers may be supported for Rel-10) which may be a limitation for mobile relays where the channel diversity may be higher. Embodiments contemplate that a higher number of layers might be used. Furthermore, the number of layers may affect the performance of MU-MIMO for fixed and/or mobile relays.

It is contemplated that DMRS related enhancement for relay backhaul connection may include: (1) increases in the number of supported layers; (2) improvement of DMRS OCC design and/or symbol mapping and/or (3) reduction in DMRS overhead, among others.

Embodiments contemplate orthogonal cover code(s) (OCC) in the time domain. In E3, the last 2 OFDM symbols in the second timeslot do not contain any DMRS because the last OFDM symbol of the second timeslot is not available to the relay because of delays. The OFDM symbol prior to the last symbol in the second timeslot may be accessible to the relay and may be used for the DMRS mapping. As shown in FIG. 5A, 3 OFDM symbols may be available for DMRS mapping in the subframe in which the DMRS groups may be located in OFDM symbol 6 and 7 in timeslot 1 and the OFDM symbol 6 in timeslot 2. One DMRS group may be transmitted on subcarriers 0, 5 and 10 (e.g., with a cyclic shift of 5 subcarriers) and a second DMRS group may be transmitted on subcarriers 1, 6 and 11 (with the same cyclic shift and a 1 subcarrier offset). By way of example, to take advantage of these 3 symbols (e.g., in one or more embodiments perhaps a maximum of 3 Resource Elements (REs) per subcarrier per PRB), a new time-domain OCC with a length of 3 may be used. In certain example embodiments, the DFT sequences, as illustrated in Table 3, may be used, where some or each OCC sequence may be orthogonal to others.

TABLE 3

| OCC Sequence | OCC Symbols |
|---|---|
| 0 | [1 1 1] |
| 1 | [1 e^{j2π/3} e^{j4π/3}] |
| 2 | [1 e^{j4π/3} e^{j2π/3}] |

Some or each DMRS groups may be associated with particular layers and may be used for channel estimation associated with particular channels. For example, some or each DMRS group may be transmitted while the other antennas or antenna groups may be silent to enable the channel estimation. By using OCC sequences associated with, for example 3 symbols, some or each DMRS groups can support up to 3 layers and in total up to 6 layers can be supported for DL MIMO. The location of the DMRS symbols associated with FIG. 5A may be a subset of those defined within the Rel-10 framework. For MU-MIMO, a plurality of (e.g., up to 3) users may be supported.

Embodiments contemplate orthogonal cover code(s) (OCC) in the frequency domain. In the Rel-10 framework, the OCCs may be applied to the same subcarrier (e.g., the OCCs are spread in time domain) due to channel condition between UEs and eNBs that can be (perhaps significantly) different between subcarriers, (e.g., the channel may be frequency selective (e.g., strongly frequency-selective)). Such channel variation may reduce (e.g., effectively reduce) the orthogonality of the OCCs. Since each subcarrier in each Resource Block (RB) may have a maximum of 4 resource elements (REs) for DMRS, OCCs (e.g., in some embodiments only OCCs) with a length of 4 may be supported, for example.

For fixed relays, the backhaul channel may be less frequency selective compared to that of the UEs and mobile relays and the OCCs may be implemented in the backhaul channel of mobile relays, for example, across different subcarriers rather than in the same subcarriers within subframes as implemented in the Rel-10 framework. This method can be implemented using any or a combination of the following approaches: (1) the REs designated for each DMRS group may be located in one or more OFDM symbol; and/or (2) the REs designated for each DMRS group may be located in one or more subcarrier.

FIG. 5B shows an example timeslot diagram where the DMRS RE locations of Rel-10 framework may be reused and REs (e.g., some or all REs) in each OFDM symbol are allocated to the same DMRS group. In FIG. 5B the OCC may have a length of 6 in the frequency domain where 6 REs in each OFDM symbol are allocated to the same DMRS group.

It is contemplated that for the DL timing of E3, the last OFDM symbol may not be available and no DMRS may be allocated to that OFDM symbol. In this case, the DMRS group 1 in the second timeslot may or may not be allocated. To take advantage of the 6 REs per OFDM symbol, among other reasons, embodiments contemplate that a frequency-domain OCC with a length of 6 may be used. In certain example embodiments, the DFT sequences illustrated in Table 4 may be used, where each OCC sequence may be orthogonal to others.

TABLE 4

| OCC Sequence | OCC Symbols |
|---|---|
| 0 | [+1 +1 +1 +1 +1 +1] |
| 1 | [+1 e^{j2π/6} e^{j4π/6} −1 e^{j8π/6} e^{j10π/6}] |
| 2 | [+1 e^{j4π/6} e^{j8π/6} +1 e^{j4π/6} e^{j8π/6}] |
| 3 | [+1 −1 +1 −1 +1 −1] |
| 4 | [+1 e^{j8π/6} e^{j4π/6} +1 e^{j8π/6} e^{j4π/6}] |
| 5 | [+1 e^{j10π/6} e^{j8π/6} −1 e^{j4π/6} e^{j2π/6}] |

By using OCCs of length 6, each DMRS group may support a plurality of layers (e.g., up to 6 layers). Although, OCCs of length 3 and 6 have been illustrated, other lengths are also contemplated (for example, when the length equals the number of carriers used for a DMRS group for an OFDM symbol).

For MU-MIMO this may translate into supporting up to 6 users. It is contemplated that the locations of the DMRS symbols may be a subset of those defined within Rel-10 framework.

The relay backhaul channel condition may be expected to be better but may be less frequency-selective than that of the regular UEs (e.g., for both fixed and mobile relays). For fixed-relays, the channel condition may be much better than that of the UEs. In certain example embodiments, the number of REs allocated to the DMRS may be reduced to reduce DMRS overhead by transmitting OCCs in a subset (in some embodiments perhaps only a portion) of the REs allocated to DMRS in Rel-10. The reduction in DMRS allocated to DMRS may be applied to the DL timing of E1 and E3, and may be used in conjunction with various example methods.

Embodiments contemplate reduced subcarrier mapping. One or more subcarriers including DMRS in Rel-10 RB and/or in Rel-11+ may not carry any DMRS REs and may instead be used (or reused) for control signaling and/or data transmission. By way of example, FIG. 5C illustrates the reduced DMRS REs in which the last two subcarriers in the RB may not include DMRS REs (e.g., any DMRS REs). In FIG. 5C, the DMRS overhead reduction may occur with the OCCs being transmitted in time-domain (e.g., on successive symbols in the first and second timeslots) while reducing the number of subcarriers transmitting DMRS (e.g., the last two subcarriers may not include DMRS REs).

The reduced subcarrier mapping may be applied to frequency-domain OCCs where DMRS symbols may not be transmitted in some of the subcarriers, which may result in a shorter frequency-domain OCC. In that case, the REs (e.g., unused REs) for those removed DMRS may be reused for control signaling and/or data transmission. By way of example, FIG. 5D illustrates the reduced frequency domain DMRS REs in which the last two symbols in the RB of the second timeslot do not include DMRS REs (e.g., any DMRS REs). In FIG. 5D, the DMRS overhead reduction occurs in both the time and frequency domains with the OCCs transmitted in time-domain (e.g., on successive symbols in the first timeslots only) while reducing the number of subcarriers transmitting DMRS (e.g., the last two subcarriers may not include DMRS REs). In this example, the last two subcarriers no longer contain any DMRS and OCCs of length 4 may be used.

Embodiments contemplate reduced OFDM symbol mapping. FIG. 5E shows an example timeslot diagram similar to that of FIG. 5B except that the DMRS REs may not be located in the last two subcarriers. For example, the DMRS REs in each OFDM symbol may be allocated to the same DMRS group (e.g., Group 1 or Group 2) and the number of subcarriers having DMRS REs may be 4 per symbol instead of 6 per symbol in FIG. 5B. In FIG. 5E, the OCC may have a length of 4 in the frequency domain where 4 REs in each OFDM symbol are allocated to the same DMRS group.

FIG. 5F shows an example timeslot diagram similar to that of FIG. 5B except that the DMRS REs may not be located in the second timeslot. For example, the DMRS REs in each OFDM symbol are allocated to the same DMRS group (e.g., Group 1 or Group 2) and the number of subcarriers having DMRS REs may be 6 per symbol as shown in FIG. 5B. In FIG. 5F, the OCC may have a length of 6 in the frequency domain where 6 REs in each OFDM symbol are allocated to the same DMRS group.

For example, one or more OFDM symbol including DMRS REs in Rel-10 may no longer carry any DMRS REs. Instead, those REs may be reused for control signaling and/or data transmission. This is illustrated in FIG. 5F in which the last two OFDM symbols no longer contain any DRMS and an OCC with a length of 6 is used.

Embodiments contemplate multi-user MIMO (MU-MIMO). Embodiments recognize that the relay backhaul channel may be better (e.g., perhaps considerably better) than that of the UEs (e.g., it may have a higher SINR). In certain example embodiments, a method may use SU-MIMO multiplexing gain to take advantage of such a high SINR. In certain example embodiments, other methods may apply MU-MIMO, perhaps when channel conditions may be above a threshold level (e.g., the SINR exceeds the threshold producing a strong channel condition). The current Rel-10 framework for MU-MIMO may support (e.g., may only support) up to 4 layers where the first two layers may be orthogonal (in some embodiments perhaps only the first two layers). In Rel-10 framework, MU-MIMO may not be used for control channels due to the use of a robust control channel for UEs. The channel condition for relay backhaul, however, may meet or exceed these conditions and, thus may already be strong. There might be an extra margin for the use of MU-MIMO for the control channel, which in turn may reduce the resources occupied by the control channel. In certain example embodiments, the relay backhaul resources may be shared between control and data channels. Reducing the resource allocation for the control channel may result (e.g., eventually result) in a higher capacity for the data channel and a higher system throughput.

Embodiments contemplate that the use of MU-MIMO between relay control channels and other relays and/or UEs data channels might be useful. The relay backhaul connection may be enhanced by MU-MIMO to: (1) improve of the number of supported layers and/or number of orthogonal layers; (2) use MU-MIMO for RN control channel; and/or (3) use MU-MIMO between RNs and macro UEs.

Embodiments contemplate the increase of MU-MIMO layers for RN data channels. Several DMRS REs configurations are shown in FIGS. 5A to 5F. In certain example embodiments, OCC may be used with lengths of 3 to 6. By using those configurations, orthogonal layers of 3 to 6 per DMRS group may be reached, respectively. Based on the MU-MIMO scrambling method, the total number of MU-MIMO data channel layers may be doubled from that of the Rel-10 framework.

Embodiments contemplate MU-MIMO layers for RN control channels. To use MU-MIMO for the relay control channel, configuration information may be communicated to the relay before the actual transmission of the control channel. This corresponds to (e.g., is similar to or equivalent with) the process provisioned for data channel MU-MIMO where some configuration is communicated to the UE via the control channel prior to the actual data channel transmission. The MU-MIMO configuration information used for the control channel may include, but is not limited to the following: (1) the reference signal antenna port; (2) the OCC index (3) the number of layers; (4) the reference-signal scrambling sequence used to generate the reference signals; and/or (5) PMI information, among others.

Embodiments contemplate that some (or all) of these parameters may be set and/or determined at the RN using one or a combination of the following methods: (1) set to default value(s); (2) received by the RN, as an RN-specific message and/or configuration parameter (for example, the DeNB may divide the RNs (e.g., all RNs) into two or more groups each configured to receive control channel based on a specific set of parameters, e.g., antenna ports); (3) determined at the RN by blind decoding; and/or (4) set or determined to be the same as those set for the PDSCH transmission (e.g., possibility the last PDSCH transmission), among others. By way of an example, the scrambling sequence seed (e.g., n_{SCID}) may be assumed to be 0 and only two antenna ports (ports 7 and 8 may be supported) (e.g., only two possible OCCs corresponding to the support of 2 RNs). In this case, the antenna port may not be specified in advance, and the RN may use blind decoding for both OCCs and then chose the one with the higher SINR.

Embodiments contemplate MU-MIMO between RNs and macro UEs (mUEs). To apply MU-MIMO between RNs, or RNs and mUEs, MIMO configurations (e.g., in some embodiments perhaps only MIMO configurations) may be used which are supported by users (e.g., some or all users).

Within the Rel-10 relay framework, when the last OFDM symbol is not accessible by the RN in DL timing for E3 (e.g., the configuration 1 in Table 2), the reference signals may be transmitted (only transmitted) in the first time slot and the 6^{th} OFDM symbol in the second timeslot may contain data for the RN. In the case of MU-MIMO, the same OFDM symbol may contain DMRS for the mUE, which may not be orthogonal to the data transmitted to the RN in that symbol. Consequently, the RN data may affect (e.g., considerably affect) the channel estimation of the mUEs and may degrade the mUE performance. To address this, in certain example embodiments, the DeNB may not transmit any information to the RN in the original locations of DMRS in the second timeslot. Alternatively, the DL grant and/or RN configuration message may include information indicating whether or not the DMRS locations in the second timeslot are allocated to RN data when configuration 1 of Table 2 may be used. In other example embodiments, a new configuration may be defined for the second timeslot indicating the use of the first 5 OFDM symbols (and perhaps in some embodiments only those symbols (e.g., see Table 5, configuration 2). Table 5 shows OFDM symbols for eNB-to-RN transmission in the second slot (e.g., with normal CP and Δf=15 kHz) with additional configurations.

TABLE 5

| Configuration | Start symbol index | End symbol index |
|---|---|---|
| 0 | 0 | 6 |
| 1 | 0 | 5 |
| 2 | 0 | 4 |

For example, the end symbol in configuration 0 may be 6, the end symbol in configuration 1 may be 5, and the end symbol in configuration 2 may be 5. Embodiments contemplate that as many as 7 symbols (e.g. one or more of the first 7 symbols) may be used for the second timeslot, for example in configuration 0.

In view of the description herein and the FIGS. 1A-5F, embodiments contemplate one or more devices that may comprise a processor. In one or more embodiments, the processor may be configured, at least in part, to generate one or more orthogonal cover codes (OCCs) as a reference for demodulation at a reception end of a backhaul link. The processor may also be configured to allocate the one or more OCCs in one or more demodulation reference signal (DRS) groups to one or more resource elements of one or more orthogonal frequency division multiplexed (OFDM) symbols associated with a subframe. In one or embodiments, the one or more OCCs may be generated in the time domain. In one or more embodiments, each of the one or more OCCs may have a length of at least two OCC symbols. Alternatively or additionally, in some embodiments the one or more OCCs may be generated in the frequency domain. In one or more embodiments, each of the one or more OCCs may have a length of up to six OCC symbols. Alternatively or additionally, embodiments contemplate that the one or more OCCs may be generated in one or more OCC sequences, where each of the one or more OCC sequences may include the up to six OCC symbols per the one more OCCs. Further, in some embodiments, each of the respective OCC sequences may be orthogonal to the other OCC sequences.

Alternatively or additionally, in one or more embodiments, the processor may be further configured to allocate the one or more OCCs in the one or more DRS groups such that each respective DRS group may be allocated with at least one of a respectively different timing in the subframe or a respectively different frequency in the subframe. Alternatively or additionally, one or more embodiments contemplate that the processor may be further configured to allocate the one or more OCCs in the one or more DRS groups in at least one of a first timeslot of the subframe such that the OCCs of each of the one or more respective DRS groups may not be allocated to a second timeslot of the subframe, or a first subset of subcarriers of the subframe such that the OCCs of each of the one or more respective DRS groups may not be allocated to one or more beginning subcarriers of the subframe or one or more ending subcarriers of the subframe.

Alternatively or additionally, one or more embodiments contemplate that the subframe may have at least a first timeslot and a second timeslot and the processor may be further configured to allocate the one or more OCCs in the one or more DRS groups in a second timeslot of the subframe such that the OCCs of each of the one or more respective DRS groups may be allocated to at least one of a first seven symbols of the one or more OFDM symbols associated with the second timeslot of the subframe.

Alternatively or additionally, one or more embodiments contemplate that the processor may be further configured to select one of a plurality of DRS group patterns defined by positions of the OCCs in one or more resource blocks of the subframe. In some embodiments, the allocating of the one or more OCCs in the one or more DRS groups may be based on the selected one of the DRS patterns.

Alternatively or additionally, one or more embodiments contemplate that the allocating of the one or more OCCs in the one or more DRS groups to the one or more resource elements of one or more OFDM symbols may include allocating the DRS groups to consecutive OFDM symbols in a resource block of the subframe.

Alternatively or additionally, one or more embodiments contemplate that the device may be at least one of a fixed relay node or a mobile relay node, and the processor may be further configured to initiate a backhaul communication including the subframe to another device. Alternatively or additionally, the device may be at least one of a base station, a donor evolved node-B (DeNB), or an evolved node-B (eNB).

Embodiments contemplate one or more methods that may include generating one or more orthogonal cover codes (OCCs) by a first device of a wireless communication network as a reference for demodulation at a reception end of a backhaul link between the first device and a second device of the wireless communication network. One or more embodiments also contemplate allocating by the first device the one or more OCCs in one or more demodulation reference signal (DRS) groups to one or more resource elements of one or more orthogonal frequency division multiplexed (OFDM) symbols associated with a subframe. One or more embodiments contemplate that the generating the one or more OCCs may include generating the one or more OCCs in the frequency domain in OCC sequences. Also, some embodiments contemplate that the one or more OCCs may have a length of up to six OCC symbols. In one or more embodiments, each of the one or more OCC sequences may include the up to six OCC symbols per the one or more OCCs. Embodiments also contemplate that each of the respective OCC sequences may be orthogonal to the other OCC sequences.

In one or more embodiments, the allocating the one or more OCCs in the one or more DRS groups to the one or more resource elements of the one or more orthogonal frequency division multiplexed (OFDM) symbols may include allocating the one or more DRS groups to adjacent OFDM symbols of the subframe such that the resource elements corresponding to the adjacent OFDM symbols may correspond to a common subcarrier. Alternatively or additionally, one or more embodiments contemplate that the allocating the one or more OCCs in the one or more DRS groups to the one or more resource elements of the one or more orthogonal frequency division multiplexed (OFDM) symbols may include allocating the DRS groups to adjacent OFDM symbols of the subframe such that the resource elements corresponding to the adjacent OFDM symbols may correspond to at least one different subcarrier.

One or more embodiments contemplate one or more devices that may include a processor. The processor may be configured, at least in part, to establish a backhaul link to a second device with more than four multiple-input-multiple-output (MIMO) layers. In one or more embodiments, the processor may be configured to initiate communication to the second device via more than four antenna using corresponding layers of the more than four MIMO layers. In some embodiments the communication may include configuration information for a control channel for the second device to operate the backhaul link with the more the four MIMO layers. In one or more embodiments, the configuration for the control channel may include at least one of a reference signal antenna port, an orthogonal cover code (OCC) index, a number of layers, a reference signal scrambling sequence, or a precoding matrix indicator (PMI). One or more embodiments contemplate that the second device is a relay node.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

In addition, although the embodiments are illustrated and described herein with reference to specific example, the embodiments are not intended to be limited to the details shown. Rather, various modifications may be made in the details within the scope and range of equivalents of the claims and without departing from the contemplated embodiments.

What is claimed is:

1. A device, comprising:
a processor, the processor configured, at least in part, to:
generate one or more orthogonal cover codes (OCCs) as a reference for demodulation at a reception end of a backhaul link; and
allocate the one or more OCCs in one or more demodulation reference signal (DRS) groups to one or more resource elements of one or more orthogonal frequency division multiplexed (OFDM) symbols associated with a subframe.

2. The device of claim 1, wherein the one or more OCCs are generated in the time domain.

3. The device of claim 2, wherein each of the one or more OCCs have a length of at least two OCC symbols.

4. The device of claim 1, wherein the one or more OCCs are generated in the frequency domain.

5. The device of claim 4, wherein each of the one or more OCCs have a length of up to six OCC symbols.

6. The device of claim 5, wherein the one or more OCCs are generated in one or more OCC sequences, each of the one or more OCC sequences includes the up to six OCC symbols per the one or more OCCs, and each of the respective OCC sequences is orthogonal to the other OCC sequences.

7. The device of claim 1, wherein the processor is further configured to allocate the one or more OCCs in the one or more DRS groups such that each respective DRS group is allocated with at least one of a respectively different timing in the subframe or a respectively different frequency in the subframe.

8. The device of claim 1, wherein the processor is further configured to allocate the one or more OCCs in the one or more DRS groups in at least one of: a first timeslot of the subframe such that the OCCs of each of the one or more respective DRS groups are not allocated to a second timeslot of the subframe, or a first subset of subcarriers of the subframe such that the OCCs of each of the one or more respective DRS groups are not allocated to one or more beginning subcarriers of the subframe or one or more ending subcarriers of the subframe.

9. The device of claim 1, wherein the subframe has at least a first timeslot and a second timeslot and the processor is further configured to allocate the one or more OCCs in the one or more DRS groups in a second timeslot of the subframe such that the OCCs of each of the one or more respective DRS groups are allocated to at least one of a first seven symbols of the one or more OFDM symbols associated with the second timeslot of the subframe.

10. The device of claim 1, wherein the processor is further configured to:
select one of a plurality of DRS group patterns defined by positions of the OCCs in one or more resource blocks of the subframe, wherein the allocating of the one or more OCCs in the one or more DRS groups is based on the selected one of the DRS patterns.

11. The device of claim 1, wherein the allocating of the one or more OCCs in the one or more DRS groups to the one or more resource elements of one or more OFDM symbols includes allocating the DRS groups to consecutive OFDM symbols in a resource block of the subframe.

12. The device of claim 1, wherein the device is at least one of a fixed relay node or a mobile relay node, and the processor is further configured to initiate a backhaul communication including the subframe to another device.

13. The device of claim 1, wherein the device is at least one of a base station, a donor evolved node-B (DeNB), or an evolved node-B (eNB).

14. A method, comprising:
generating one or more orthogonal cover codes (OCCs) by a first device of a wireless communication network as a reference for demodulation at a reception end of a backhaul link between the first device and a second device of the wireless communication network; and
allocating by the first device the one or more OCCs in one or more demodulation reference signal (DRS) groups to one or more resource elements of one or more orthogonal frequency division multiplexed (OFDM) symbols associated with a subframe.

15. The method of claim 14, wherein the generating the one or more OCCs includes generating the one or more OCCs in the frequency domain in OCC sequences, the one or more OCCs having a length of up to six OCC symbols, each of the one or more OCC sequences including the up to six OCC symbols per the one or more OCCs, and each of the respective OCC sequences is orthogonal to the other OCC sequences.

16. The method of claim 14, wherein the allocating the one or more OCCs in the one or more DRS groups to the one or more resource elements of the one or more orthogonal frequency division multiplexed (OFDM) symbols includes allocating the one or more DRS groups to adjacent OFDM symbols of the subframe such that the resource elements corresponding to the adjacent OFDM symbols correspond to a common subcarrier.

17. The method of 14, wherein the allocating the one or more OCCs in the one or more DRS groups to the one or more resource elements of the one or more orthogonal frequency division multiplexed (OFDM) symbols includes allocating the DRS groups to adjacent OFDM symbols of the subframe such that the resource elements corresponding to the adjacent OFDM symbols correspond to at least one different subcarrier.

18. A first device, comprising:
a processor, the processor configured, at least in part, to:
establish a backhaul link to a second device with more than four multiple-input-multiple-output (MIMO) layers; and
initiate communication to the second device via more than four antenna using corresponding layers of the more than four MIMO layers, the communication including configuration information for a control channel for the second device to operate the backhaul link with the more the four MIMO layers.

19. The first device of claim 18, wherein the configuration for the control channel includes at least one of a reference signal antenna port, an orthogonal cover code (OCC) index, a number of layers, a reference signal scrambling sequence, or a precoding matrix indicator (PMI).

20. The first device of claim 18, wherein the second device is a relay node.
